(19) United States
(12) Patent Application Publication
(10) Pub. No.: US 2006/0205302 A1
(43) Pub. Date: Sep. 14, 2006

(54) Film lined airbag

(75) Inventor: Mark C. Woydick, Lake Orion, MI (US)

Correspondence Address: FOLEY AND LARDNER LLP;SUITE 500, 3000 K STREET NW, WASHINGTON, DC, 20007, US

(73) Assignee: TAKATA RESTRAINT SYSTEMS, INC.

(21) Appl. No.: 11/076,103

(22) Filed: Mar. 9, 2005

(51) Int. Cl. B31B 45/00; B32B 5/22; B32B 1/08; B29D 23/00; B32B 5/02

(52) U.S. Cl. 442/76; 442/149; 280/728.1; 428/34.1

(57) ABSTRACT

An side curtain airbag constructed from two layers of fabric. At least one of the fabric layers is covered with a low permeability film layer. The film layer may be a thermoplastic elastomer and may be laminated onto the fabric layer.

### BACKGROUND

The present invention is generally related to airbags. More specifically, the present invention is related to curtain type airbags.

Inflatable airbags have become standard equipment in modern automobiles. Current airbags are typically constructed of woven fabric to form an airbag. The woven base fabric is typically partially sealed using various silicone based coatings to reduce air permeability. Two fabric layers may be sewn or woven together in a manner that creates at least one chamber for gas retention when the cushion is inflated during a crash event. Current airbags by the nature of their woven and sewn constructions are naturally porous, allowing air leakage over short periods of time. In certain safety applications, it is desirable to provide a more fully inflated cushion over longer periods of time. To significantly reduce air permeability from the functional chambers of the airbag, methods are needed to significantly reduce the gas pressure loss from the airbag chambers of a typical woven and sewn fabric airbag. Sewn or woven seams between chambers and between chambers and the outside perimeter of the cushion provide leak paths. In sewn cushions, a leak path exists both through the needle penetrations and also between the stitches themselves. Woven cushions have a resulting leak path between the construction threads of the woven joint.

These leak paths are partially sealed in a variety of manners including silicon based coatings, various adhesive type sealants and gasket type materials. Thus, current airbags exhibit air permeability. However, there is a need for airbags having a low air permeability. Certain types of airbags operate best when the airbag remains inflated for an extended period of time. Most front impact airbags are designed to deflate quickly to help dissipate the impact energy upon a collision event. However, curtain-type airbags function not only to cushion impact but to protect a vehicle occupant from debris. In addition, accidents where a curtain-type airbag are used often result in multiple side impact incidents, such as a roll-over situation. In this instance, it is desirable for the airbag to remain inflated after the initial impact of the occupant with the airbag.

Various means have been used previously in an attempt to reduce airbag permeability. For example, neoprene, silicones and the like have been utilized to provide a low permeability to airbags. Generally, the coated material acts a low permeability layer to prevent or greatly reduce the escape of gas from the inside of the airbag. Traditional airbags utilize a gas inflation mechanism for inflating the airbag with gas. The coating material obstructs the permeation of the fabric with such gas, thereby permitting the airbag to rapidly inflate without undue decompression during a collision event.

However, such traditional materials have several disadvantages. The materials are heavy and thus greatly increase the weight per square centimeter of airbag surface. The increased weight can greatly increase the overall cost of an airbag module. In addition, such materials exhibit poor properties such as tensile strength and elongation at break which are relevant to airbag functionality. Furthermore, such materials often cause problems when utilized in cushion-type airbags due to the fact that such airbags are generally rolled or folded and housed in a module. The increased weight and presence of the traditionally used materials have caused airbags to have an increased deploying time, at least in part, due to blocking (i.e. adhering together of the different coated portions of the airbag), which may require more powerful inflator mechanisms.

Thus, there is a need in the art for an improved airbag which may eliminate or reduce the disadvantages described above.

### SUMMARY

The present invention relates to an airbag for vehicles, having a first fabric layer, a second fabric layer, and at least one low permeability layer. The airbag has at least one chamber formed by affixing the first fabric layer, the second fabric layer, and the at least one low permeability layer to each other. This chamber is adapted to hold the gas upon inflation of the airbag. A method of forming an airbag having a first fabric layer, a second fabric layer, and a low permeability layer is also provided.

It is to be understood that both the foregoing general description and the following detailed description are exemplary and explanatory only and are not restrictive of the invention as claimed.

### BRIEF DESCRIPTION OF THE DRAWINGS

These and other features, aspects, and advantages of the present invention will become apparent from the following description, appended claims and the accompanying exemplary embodiments shown in the drawings, which are briefly described below.

FIG. 1 is an illustration of the side, interior view of a vehicle prior to deployment of an airbag of the present invention.

FIG. 2 is an illustration of the side, interior view of a vehicle after deployment of an airbag.

FIG. 3 is a partial cross-sectional view of an airbag having a film layer laminated to a fabric layer according to an embodiment of the present invention.

FIG. 4 is a partial cross-sectional view of an airbag having a film layer covering a fabric layer according to an embodiment of the present invention.

FIG. 5 is a partial cross-sectional view of an airbag having an exterior film layer according to an embodiment of the present invention.

FIG. 6 is a partial cross-sectional view of an airbag having two laminated fabric layers according to an embodiment of the present invention.

FIG. 7 is a partial cross-sectional view of an airbag having two film layers according to an embodiment of the present invention.

### DETAILED DESCRIPTION

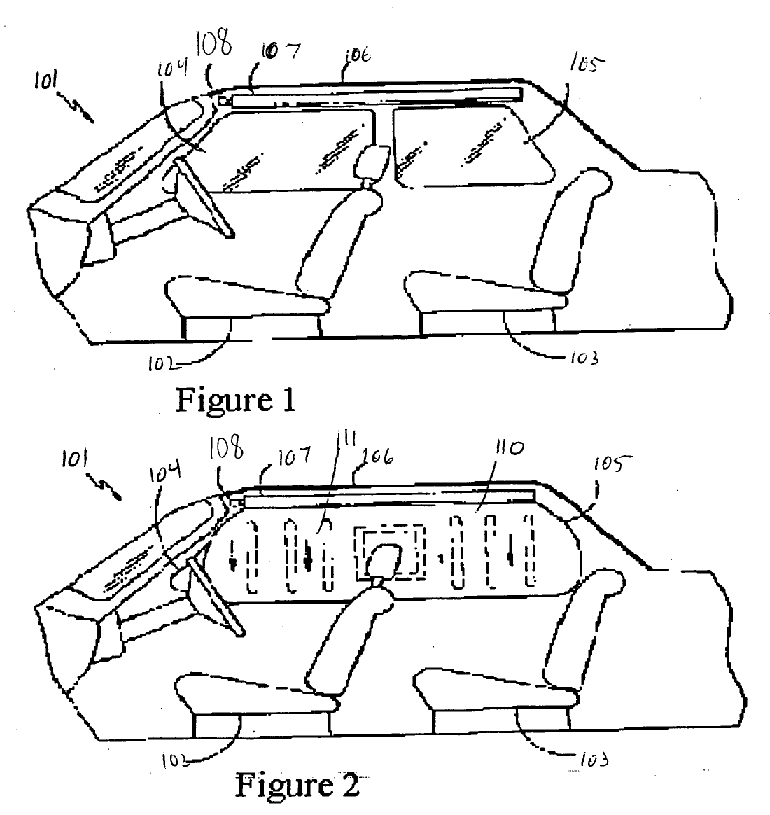

As seen in FIGS. 1 and 2, according to an embodiment of the present invention, an airbag 110 may be a side curtain airbag. As shown in FIG. 1, an exemplary vehicle 101 includes a front seat 102 and a back seat 103, a front side window 104 and a back-side window 105, a roofline 106 wherein the airbag (not shown) of the present invention is stored in the stowed state in a cylindrically shaped container 107. An inflator assembly 108 may be provided within the roofline 106. The inflator 108 may be any of the various types known in the art which are capable of forcing gas into the airbag upon a collision event.

FIG. 2 illustrates the vehicle airbag apparatus of FIG. 1, with an airbag 110, shown as a side curtain airbag, deployed. A curtain airbag 110 of the present invention is deployed when the inflator 108 is activated upon a collision event, thus inflating the chambers, or bladder, 111 of the airbag 110. Due to the low permeability layer 115 of the present invention, the chambers 111 of the airbag 110 retain the gas longer than the prior art airbags having a high gas permeability. In one embodiment, the airbag 110 will remain sufficiently inflated for at least 5 seconds, in another exemplary embodiment, longer than ten seconds, and in yet another exemplary embodiment longer than twenty seconds.

The airbag 110 may include a low permeability layer 115 comprising one or more combinations of thermoplastic elastomers. The low permeability layer 115 of the airbag functions as a gas low permeability boundary inside of the airbag to provide for a lower peak pressure to ensure adequate cushion and a lower volume output inflator while also allowing for the use of lower cost, more porous, structural fabrics.

As shown in FIG. 3, according to an embodiment of the present invention, the airbag 110 may be formed to include multiple layers. For example, the airbag may include a first fabric layer 113 adjacent the vehicle structure coated or covered with at least one low permeability layer 115. A second fabric layer 114 adjacent the vehicle cabin is combined with the first fabric layer 113 to form a chamber for holding gas. The layers may be connected together to form a relatively tight gas seal using stitching 116, silicon or other suitable sealing method.

According to an embodiment of the present invention, the low permeability layer 115, may comprise a thermoplastic elastomer (TPE) which is formed into a sheet. The film layer 115 may be laminated onto the first fabric layer 113 to form a laminated fabric layer.

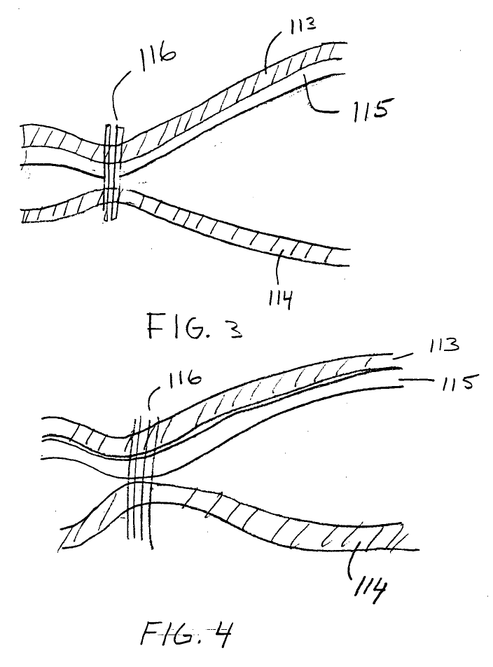

In one exemplary embodiment, the present invention comprises a single low permeability layer 115. The low permeability layer 115 may be either a film layer 115 that positioned adjacent or laminated onto the first fabric layer. As shown in FIGS. 4, the low permeability layer 115 is positioned adjacent to the fabric layer 113 but is not laminated onto the fabric. The low permeability layer 115 may be positioned on either the inner (cabin side) or outer (window side) fabric layer. Furthermore, the low permeability layer 115, may be adhered to either the interior side (inflation gas side) or the exterior side of the fabric layer. For example, as shown in FIG. 5, the low permeability layer 115 is positioned between the first fabric layer 113 and the window or cabin wall.

In certain circumstances, placement of the low permeability TPE layer on the interior side of the first fabric layer 113 may be preferred so that the pressure of the inflation gas only serves to enhance the seal between the fabric and the low permeability layer. Furthermore, the first fabric layer may provide a protective barrier against shattered glass or other projectile that could damage the film layer. In one embodiment, the vehicle side fabric layer includes a rip stop fabric comprising yarns of approximately 420 denier. In another embodiment the yarn size is approximately 630 denier. In yet another embodiment the yarn size is approximately 840 denier.

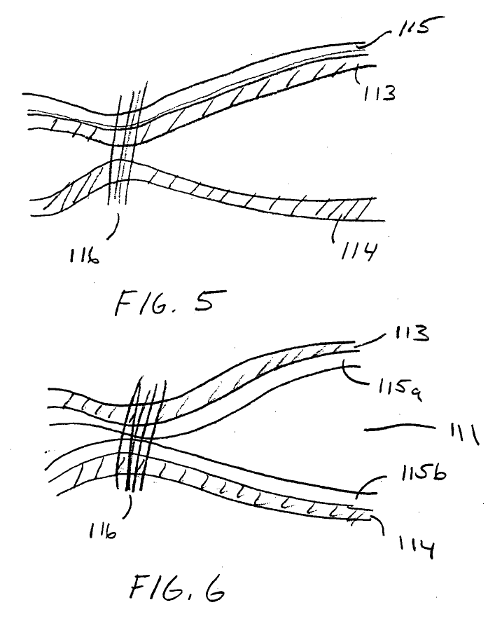

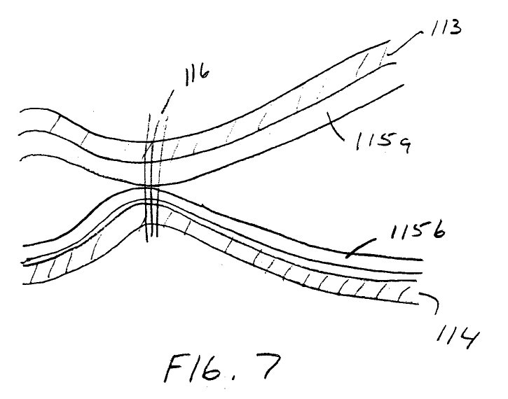

According to another embodiment, as shown in FIG. 6, the airbag may include two separate low permeability layers 115a, 115b. The low permeability layers may comprise TPE film layers. One or both of the film layers 115a, 115b may be laminated to the fabric layers. The film layers 115a, 115b may be joined together via heat sealing (or other well known suitable methods) to provide relatively gas tight chambers 111. Alternatively, or in addition to the heat sealing, the four layers of material, i.e. the two low permeability layers 115a, 115b and the two fabric layers 113, 114, are stitched together to form a structural assembly.

As shown in FIG. 7, according to an embodiment of the present invention, the airbag may include two low permeability layers 115a, 115b. The first low permeability layer 115a may comprises a film laminated onto the first fabric layer 113. The second low permeability layer 115b may be positioned adjacent the second fabric layer 114. The two low permeability layers 115a, 115b may be joined together in select areas forming gas retention chambers 11 using a variety of methods including, but not limited to, radio frequency, heat sealing, ultrasonic, or adhesive type bond. The chambers 115 may be structurally re-enforced at the chamber boundaries by mechanical sewing, for example, joining all the layers of fabric 113, 114 and low permeability layers 115a, 115b.

In another embodiment, a gas retaining film bladder may be created which is then assembled between and contained within the fabric layers 113, 114 during final cushion construction using sewing methods. In another embodiment, the gas retention film bladder may be partially attached to the outside fabric structure during the sewing process to aid in keeping the “bladder” located within the finished airbag 110.

According to the embodiment shown in FIG. 7, the airbag may include a first fabric layer 113 and a second fabric layer 11 4. The first fabric layer may be laminated with a first film layer 115a. The second fabric layer 114 may be covered by a film layer 115b. The first and second film layers 115a, 115b are positioned so that the film surfaces are in contact. The film layers 115a, 115b may be joined via a form of heat sealing to form air tight chambers 111. The film layers 115a, 115b may be joined after the first film layer 115a is laminated to the first fabric layer 113, but before the second film layer 115b is connected to the second fabric layer. Alternatively, the joining of the film layers 115a, 115b may be conducted after the second film layer 115b is connected to the second fabric layer 114.

The heat sealing step can be any of the various methods known in the art such as, but not limited to, radio frequency, heat sealing, and ultrasonic sealing. The connection between the fabric and film layers may also include a sewn seam preferably centrally located within the heat sealing zone or joint.

As shown in FIG. 6, the first and second fabric layers 113, 114 may both be laminated with film layers 115a, 115b. The two laminated fabric layers may be joined via a form of heat sealing to form air tight chambers 111 between the laminated fabric layers . The heat sealing step can be any of the various methods known in the art such as, but not limited to, radio frequency, heat sealing, and ultrasonic sealing. The laminated fabric layers may also be sewn together. A shown in FIG. 6, the sewn seam 116 is preferably near the center of the heat sealed area or joint.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined as set forth in the following claims.

1. An airbag for vehicles comprising:
a first fabric layer and a second fabric layer, the first fabric layer comprising rip stop material;
a thermoplastic film layer positioned adjacent one of the fabric layers; and
at least one chamber formed by joining the first fabric layer, the second fabric layer, and the film layer together.

2. The airbag of claim 1, wherein the film layer is laminated to one of the fabric layers.

3. The airbag of claim 1, further comprising a second thermoplastic film layer.

4. The airbag of claim 3, wherein the first film layer is laminated to one of the fabric layers.

5. The airbag of claim 4, wherein the second film layer is laminated to the other one of the fabric layers.

6. The airbag of claim 1, wherein the first and second fabric layers and the film layer are connected together at joints which include a sewn seam.

7. The airbag of claim 3, wherein the film layers are joined together by a mechanism chosen from the group consisting of radio frequency, heat sealing, ultrasonic, or adhesive.

8. A method of forming an airbag for a vehicle, comprising the steps of:
laminating a film layer to a first fabric layer the first fabric layer comprising rip stop material; and
connecting the laminated first fabric layer to a second fabric layer to thereby form a gas retaining chamber in airbag.

9. The method of claim 8, further comprising the step of providing a second film layer between the laminated first fabric layer and the second fabric layer and wherein the connecting step includes connecting the second film layer to the laminated first fabric layer.

10. The method of claim 9, further comprising the step of laminating the second film layer to the second fabric layer.

11. A side curtain airbag comprising:
a first fabric layer on a vehicle side of the airbag, the first fabric layer comprising rip stop material; and
a second fabric layer on a cabin side of the airbag;
wherein the cabin side of the first fabric layer is laminated with a thermoplastic film layer.

12. (canceled)

13. The side curtain airbag of claim 11, wherein the first fabric layer includes yarns of a size of approximately 420 denier.

14. The side curtain airbag of claim 11, further comprising a second thermoplastic film layer bonded to the first film layer at select locations in order to form gas retention chambers.

15. The side curtain airbag of claim 14, wherein the second film layer is laminated to the second fabric layer.

16. The airbag of claim 1, wherein first fabric layer is located on a vehicle side of the airbag.

17. The method of claim 8, wherein the first fabric layer is located on a vehicle side of the airbag.

18. The airbag of claim 1, wherein the film layer is laminated to one of the fabric layers on an inside surface of the airbag.
